(19) United States
(12) Patent Application Publication
(10) Pub. No.: US 2026/0177095 A1
(43) Pub. Date: Jun. 25, 2026

(54) COUPLING DEVICE WITH SLIDING MECHANISM AND METHOD OF USE THEREOF

(71) Applicant: Spiral Master Corp., Mississauga (CA)

(72) Inventor: Allen HAMILTON, Hamilton (CA)

(21) Appl. No.: 18/986,946

(22) Filed: Dec. 19, 2024

Related U.S. Application Data
(63) Continuation-in-part of application No. PCT/CA2023/051085, filed on Aug. 16, 2023.
(60) Provisional application No. 63/398,341, filed on Aug. 16, 2022.

(51) Int. Cl. F16B 33/02

(52) U.S. Cl. CPC F16B 33/02

(57) ABSTRACT

A coupling device, such as a sliding nut and bolt device is disclosed. A female component includes a plurality of threaded protrusions, each of a different size. A male component bolt a plurality of longitudinal slots matching the threaded protrusions and a plurality of sets of threads. The female component is slidingly coupled longitudinally with the male component when each of the plurality of threaded protrusions are aligned and engaged with each of the plurality of slots. A clamped joint between the female and male components is formed when each of the plurality of threaded protrusions are engaged with each of the plurality of threads and a clamped force is attained.

### FIELD OF THE INVENTION

The present invention relates generally to coupling devices. More specifically, the present invention relates to a coupling device with a sliding mechanism for quickly fastening a female component of the coupling device to a male component of the coupling device.

### BACKGROUND OF THE INVENTION

Coupling devices are used to join two objects together, enabling them to function as a unit. These devices are widely employed in engineering, construction, and everyday applications, offering strength, stability, and often the flexibility to disassemble when needed. Common coupling devices include bolted joints, which rely on bolts and nuts to securely fasten components, and threaded fittings, which, feature male and female threads that screw together to form a secure connection. The nut and bolt stands out as one of the simplest and most versatile examples of coupling devices. A bolt, threaded along its length, passes through aligned holes in the objects to be joined, while a nut with complementary internal threading is tightened onto the bolt, creating a secure clamping force and preventing axial movement. To provide a secure fastening, the nut typically relies on torque being applied to generate an axial force. This axial force causes sufficient friction at the threads so as to prevent the nut from unscrewing. The force may act between a bolt head of the bolt and the nut, causing compression of the objects being held or fastened together. Only a small amount of rotation (e.g., 15 degrees) of the bolt or the nut is required to transition from almost no clamping force to a full clamp load in a bolted joint. In an assembly, most of the rotation of the nut after the nut contacts a clamping surface only pulls the joint together. Threaded fittings, another widely used coupling device, rely on threads on the surfaces of the objects being joined to provide a strong mechanical hold, with male threads on one object screwing into female threads on the other object.

Male components (e.g., bolt or object on which the male threads are disposed) of these coupling mechanisms can have different number of threads or lengths of threaded area depending on a thickness of the objects they are fastening. Accordingly, a number of threads, or a length of threaded area on the male component also varies, based on dimensions of the male component. In the case of the bolt and nut, right after the nut is engaged with a first thread of the bolt, the nut is rotated until the nut contacts a clamping surface or the bolt head. This may take a long time depending on the length of the threaded area or the length of the bolt. The same challenge may be encountered with threaded fittings. A female component that can quickly translate along the male component into contact with a clamping surface or blocking border or end surface and provide the desired clamping force or mechanical hold with a quick rotation of the female component is needed. As such, an objective of the present invention is to provide a coupling device for fastening objects together quickly and easily and with a minimum number of rotations of the female component.

### SUMMARY OF THE INVENTION

Aspects of the invention provide a coupling device, including: a female component including a plurality of sets of threaded protrusions; and a male component, including: a plurality of longitudinal slots; and a plurality of sets of threads; wherein: the plurality of sets of threaded protrusions protrude from an interior surface of the female component; threaded protrusions of each set of the threaded protrusions are oriented longitudinally on the interior surface of the female component; the plurality of sets of the threaded protrusions delineate at least one longitudinal gap on the interior surface of the female component; the plurality of longitudinal slots are recessed into an exterior surface of the male component; each slot of the plurality of slots and threads of each set of the plurality of sets of threads are oriented longitudinally on the exterior surface of the male component and are arranged around a circumference of the male component in alternation; a number of longitudinal slots match a number of sets of threaded protrusions; each longitudinal slot of the plurality of longitudinal slots is sized to receive a respective set of threaded protrusions; a number of the at least one longitudinal gap match a number of sets of threads; each longitudinal gap of the at least one longitudinal gap is sized to receive a respective set of threads; a dimension of the threaded protrusions of each set of the plurality of sets of threaded protrusions differ; a dimension of each longitudinal gap of the at least one longitudinal gap differ; and a dimension of each longitudinal slot of the plurality of longitudinal slots differ.

Aspects of the invention include a method for operating a coupling device, including: aligning each set of threaded protrusions protruding from an interior surface of a female component of the coupling device with a longitudinal slot recessed in an exterior surface of a male component of the coupling device, the longitudinal slot being sized to receive the respective set of threaded protrusions; aligning each set of threads disposed on the exterior surface of the male component with a longitudinal gap disposed on the interior surface of the female component, the longitudinal gap being sized to receive the respective set of threads; translating the female component in a first longitudinal direction along the male component, from a first end of the male component to a second end of the male component, until reaching a desired position along the male component; and rotating the female component relative to the male component to fasten the female component onto the male component; wherein: the female component includes a plurality of sets of threaded protrusions; the male component, includes: a plurality of longitudinal slots recessed into the exterior surface of the male component; and a plurality of sets of threads; the plurality of sets of threaded protrusions protrude from the interior surface of the female component; threaded protrusions of each set of the threaded protrusions are oriented longitudinally on the interior surface of the female component; the plurality of sets of the threaded protrusions delineate at least one longitudinal gap on the interior surface of the female component; the plurality of longitudinal slots are recessed into the exterior surface of the male component; each slot of the plurality of longitudinal slots and threads of each set of the plurality of sets of threads are oriented longitudinally on the exterior surface of the male component and are arranged around a circumference of the male component in alternation; a number of longitudinal slots match a number of sets of threaded protrusions; each longitudinal slot of the plurality of longitudinal slots is sized to receive a respective set of threaded protrusions; a number of the at least one longitudinal gap match a number of sets of threads; each longitudinal gap of the at least one longitudinal gap is sized to receive a respective set of threads; the female component is rotated until: at least a portion of threaded protrusions of the plurality of sets of threaded protrusions engages with one or more of: at least a portion of threads of the plurality of sets of threads or at least a portion of other threads disposed continuously around a circumference of the male component; and a desired clamped force is attained; a dimension of the threaded protrusions of each set of the plurality of sets of threaded protrusions differ; a dimension of each longitudinal gap of the at least one longitudinal gap differ; and a dimension of each longitudinal slot of the plurality of longitudinal slots differ.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention. All illustrations of the drawings are for the purpose of describing selected versions of the present invention and are not intended to limit the scope of the present invention.

FIG. 1 illustrates a perspective view of an example of a coupling device including a nut and a bolt, according to some embodiments.

FIG. 2 illustrates a front elevation view of the nut of the coupling device in FIG. 1.

FIG. 3 illustrates a cross-sectional view of the nut in FIG. 2 along the A-A′ plane.

FIG. 4 illustrates a portion of the cross-sectional view of the nut in FIG. 3.

FIG. 5 illustrates a front elevation view of the bolt of the coupling device in FIG. 1.

FIG. 6 illustrates a cross-sectional view of the bolt in FIG. 5 along the B-B′ plane.

### DETAILED DESCRIPTIONS OF THE INVENTION

The present inventions will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well known process steps and/or structures have not been described in detail in order to not unnecessarily obscure the present invention. Further, it should be emphasized that several inventive techniques are described, and embodiments are not limited to systems implanting all of those techniques, as various cost and engineering trade-offs may warrant systems that only afford a subset of the benefits described herein or that will be apparent to one of ordinary skill in the art.

In the following detailed description of exemplary embodiments of the invention, reference is made to accompanying drawings (where like numbers represent like elements), which form a part hereof, and in which is shown by way of illustration specific exemplary embodiments in which the invention may be practiced. These embodiments are described in sufficient detail to enable those skilled in art to practice the invention, but other embodiments may be utilized, and logical, mechanical, electrical, and other changes may be made without departing from the scope of the present invention. The following detailed description is, therefore, not to be taken in a limiting sense.

Embodiments provide a coupling device including a female component and a male component. In embodiments, the female component includes an interior surface defining a through hole, hole, or cavity of the female component. In some embodiments, the interior surface is cylindrical. The female component further includes at least one set of threaded protrusions, wherein the threaded protrusions of each set of the at least one set of the threaded protrusions is oriented longitudinally on the cylindrical interior surface of the female component and protrude from the cylindrical interior surface of the female component. The at least one set of the threaded protrusions delineate at least one longitudinal gap on the cylindrical interior surface of the female component. In embodiments, the male component is cylindrical and includes at least one longitudinal slot recessed into an exterior surface of the male component. In some embodiments, the at least one longitudinal slot includes a recessed planar surface with 90 degree corners or rounded corners. In some embodiments, the at least one longitudinal slot includes a recessed half-cylinder. The male component further includes at least one set of threads, wherein the threads of each set of the at least one set of the threads is oriented longitudinally on the exterior surface of the male component. The at least one longitudinal slot and the at least one set of the threads are arranged around a circumference of the male component in alternation. In some embodiments, an end piece with a cross-sectional area greater than a cross-sectional area of the male component is fixed to a terminal end of the male component for providing a blocking border and/or an end surface for a threaded fitting and/or a bolted joint. In some embodiments, a small length of the male component proximal to a terminal end of the male component is threaded around the circumference of the male component. In some embodiments, the threads spanning the circumference of the male component include a consistent thread profile around the circumference of the male component.

The female component is slidingly coupled longitudinally with the male component by aligning each set of the at least one set of the threaded protrusions with a respective longitudinal slot of the at least one slot and aligning each longitudinal gap of the at least one longitudinal gap with a respective set of threads of the at least one set of the threads. The female component is then translated in a first longitudinal direction along the male component until reaching a desired position along the male component (e.g., proximal to the end piece, a clamping surface, or a blocking border or end surface). The female component is tightened to the desired strength to fasten the female component to the male component and/or couple objects together by rotating the female component relative to the male component until at least a portion of the threaded protrusions of the at least one set of the threaded protrusions engages with at least a portion of the threads of the at least one set of the threads and a desired clamped force is attained. The at least the portion of the threaded protrusions of the at least one set of threaded protrusions may engage with the threads disposed at the terminal end and spanning around the entire circumference of the male component to attain the desired clamped force. The engagement between the at least the portion of the threaded protrusions and the at least the portion of the threads and/or the threads disposed at the terminal end of the male component create a threaded fitting or a clamped or bolted joint and prevent axial movement.

In some embodiments, a dimension, such as an arc length, of the threaded protrusions of each set of the at least one set of the threaded protrusions and a dimension, such as an arc length or width, of each longitudinal slot of the at least one longitudinal slot varies. In some embodiments, a dimension, such as an arc length, of each set of the at least one set of the threads and a dimension, such as an arc length or width, of each longitudinal gap of the at least one longitudinal gap varies. In such embodiments, each set of the at least one set of the threaded protrusions corresponds to a particular longitudinal slot sized to receive the respective set of the at least one set of the threaded protrusions. Similarly, each set of the at least one set of the threads corresponds to a particular longitudinal gap sized to receive the respective set of the at least one set of the threads. Further, in such embodiments, the female component may be rotated 360 degrees relative to the male component before each set of the at least one set of the threaded protrusions realigns with the corresponding particular longitudinal slot sized to receive the respective set of the at least one set of the threaded protrusions. The differing arc length of the threaded protrusions of each set of the at least one set of the threaded protrusions and the differing arc length or width of each longitudinal slot of the at least one longitudinal slot allows the female component to rotate nearly 360 degrees without sliding longitudinally along the male component. With the arc length of threaded protrusions of one set of the threaded protrusions exceeding the arc length or width of each longitudinal slot, except for the longitudinal slot sized to receive the one set of the threaded protrusions, the threaded protrusions engage with the sets of threads on either side of each longitudinal slot as they align with each longitudinal slot during rotation of the female component relative to the male component, preventing the female component from sliding longitudinally along the male component.

In various embodiments, a number of any of sets of the at least one set of the threaded protrusions, longitudinal gaps of the at least one longitudinal gap, longitudinal slots of the at least one longitudinal slot, and sets of the at least one set of the threads may vary. In various embodiments, a thread size, pitch, and/or angle of the threaded protrusions of the at least one set of the threaded protrusions and the threads of the at least one set of the threads may vary. In various embodiments, a number of threaded protrusions in the at least one set of the threaded protrusions and a number of threads in the at least one set of the threads may vary. In various embodiments, a number of threaded protrusions in each set of the at least one set of the threaded protrusions and a number of threads in each set of the at least one set of the threads may vary. In various embodiments, dimensions, such as an arc length or width, depth, and/or longitudinal length, of any of each set of the at least one set of the threaded protrusions, each longitudinal gap of the at least one longitudinal gap, each longitudinal slot of the at least one longitudinal slot, and each set of the at least one set of the threads may vary. In various embodiments, a shape of each slot of the at least one slot may vary. In various embodiments, the coupling device, the female component, and/or the male component may comprise different shapes, sizes, orientations, material, component, arrangement of components, etc., so long as the objectives of the present invention are fulfilled.

In some embodiments, the coupling device described herein provides an easy, quick, and efficient means for fastening or coupling objects together. For instance, the female component may be fixed or attached to a first object and the male component may be fixed or attached to a second object and the first object and the second object are coupled together using a threaded fitting between the female component and male component of the coupling device as described herein. For example, the male component may be fixed to or integrated into an outdoor water outlet (e.g., a fire hydrant, a hose bib, a spigot, or an outdoor faucet) and may include a through hole to allow for water exiting the outdoor water outlet to pass through the male component. The female component may be fixed to a terminal end of a hose or integrated into the hose at the terminal end. The hose may be coupled to the outdoor water outlet using the threaded fitting between the female component and male component of the coupling device as described herein. In another example, the male component may be fixed or integrated into a container (e.g., tube, bottle, etc.) containing a substance (e.g., toothpaste, oil, water, glue, gas, etc.) and may include a through hole to allow for the substance to pass through the male component. The female component may be integrated into a cap and the cap may be threaded onto the male component to seal the container. In another example, two cylindrical components of a fixture are coupled together using a threaded fitting between the female component and male component of the coupling device as described herein. The male component may be integrated with a first cylindrical component on a terminal end and the female component may be integrated with a second cylindrical component on a terminal end. The first cylindrical component and the second cylindrical component may be coupled to one another using a threaded fitting between the female component and male component as described herein.

In some embodiments, the female component comprises a nut and the male component comprises a bolt including a bolt head and a bolt body. In such embodiments, the threaded protrusions of the at least one set of the threaded protrusions protrude from the cylindrical interior surface of the nut and the at least one set of the threaded protrusions delineate the at least one longitudinal gap on the cylindrical interior surface of the nut. Further, the at least one slot and the at least one set of the threads are longitudinally disposed on the bolt body and are arranged around the circumference of the bolt body in alternation. To fasten the nut to the bolt, the nut is slidingly coupled longitudinally with the bolt body by aligning each set of the at least one set of the threaded protrusions with a longitudinal slot sized to receive the respective set of the at least one set of the threaded protrusions and aligning each set of the at least one set of the threads with a longitudinal gap sized to receive the respective set of the at least one set of the threads. The nut is translated in the first longitudinal direction along the bolt body until reaching a desired position along the bolt body. To fasten nut to the bolt and/or couple objects together, the nut is tightened to the desired strength by rotating the nut until at least a portion of threaded protrusions of the at least one set of the threaded protrusions engages with at least a portion of the threads of the at least one set of the threads and a desired clamped force is attained. The at least the portion of the threaded protrusions of the at least one set of threaded protrusions may engage with the threads disposed at the terminal end and spanning around the entire circumference of the bolt body to attain the desired clamped force. The engagement between the at least the portion of the threaded protrusions and the at least the portion of the threads and/or the threads disposed at the terminal end of the bolt body create a clamped or bolted joint and prevent axial movement. The nut and bolt described herein provides a more efficient fastening mechanism than traditional nut and bolt fasteners. Preferably, the shaft of the bolt is cut to a diameter that allows the threads of the nut and bolt to align easily without jamming.

Embodiments include a method for fastening objects together using the coupling device described herein, including aligning each set of the at least one set of the threaded protrusions with a respective longitudinal slot of the at least one longitudinal slot and aligning each gap of the at least one gap with a respective set of threads of the at least one set of the threads; slidingly coupling the female component longitudinally with the male component by translating the female component along the male component in a first longitudinal direction until reaching a desired position along the male component; and rotating the female component relative to the male component until at least a portion of the threaded protrusions of the at least one set of the threaded protrusions engages with at least a portion of the threads of the at least one set of the threads or the threads disposed at the terminal end and spanning around the entire circumference of the male component and the desired clamped force is attained.

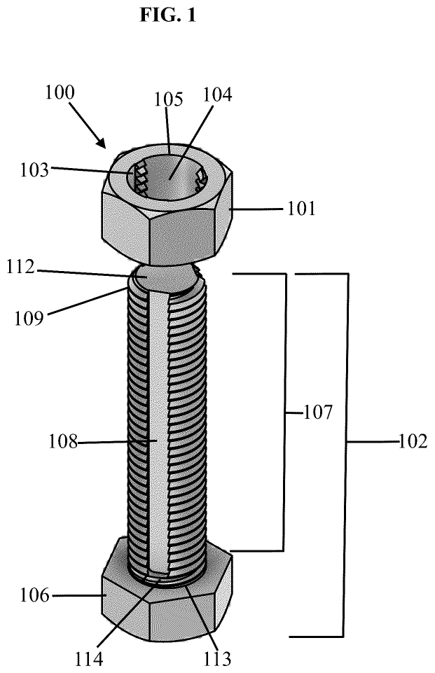

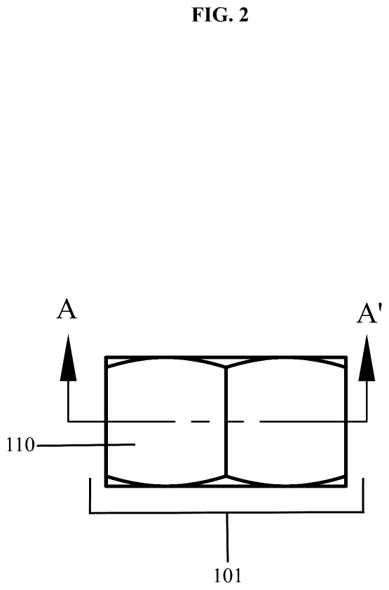

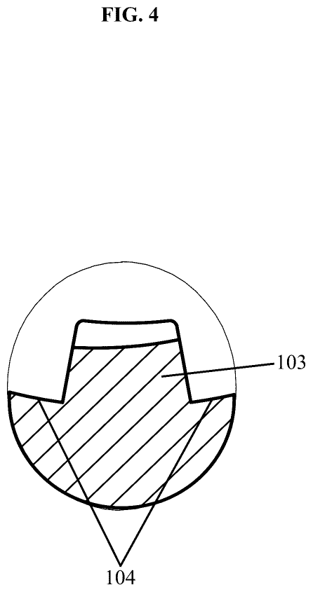

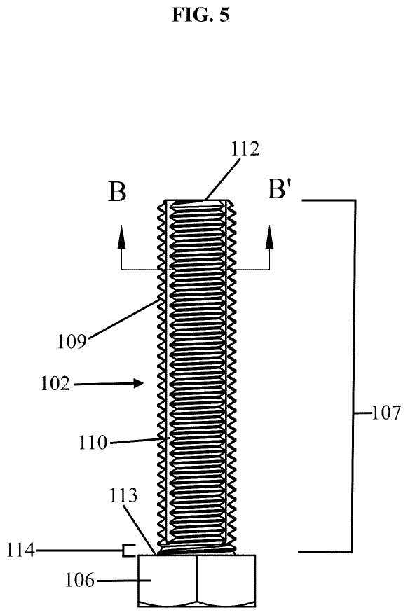

FIGS. 1-6 illustrate an example embodiment of a coupling device 100 including a nut 101 (i.e., female component) and a bolt 102 (i.e., male component). As shown in FIGS. 1-3, threaded protrusions of each set of a plurality of sets of threaded protrusions 103 protrude from a cylindrical interior surface 104 of the nut 101 and are oriented longitudinally along the cylindrical interior surface 104 of the nut 101. The plurality of sets of threaded protrusions 103 delineate each longitudinal gap of a plurality of longitudinal gaps 105 on the cylindrical interior surface 104 of the nut 101. As shown in FIGS. 1, 5, and 6, the bolt 102 includes a bolt head 106 and a cylindrical bolt body 107. The bolt body 107 includes a plurality of slots 108 and a plurality of sets of threads 109 longitudinally disposed on the bolt body 107, spanning from a first end 110 of the bolt body 107 to some distance from a second end 111 of the bolt body 107. The plurality of slots 108 and the plurality of sets of threads 109 are spaced evenly around the circumference of the bolt body 107 and in alternation. Each slot of the plurality of slots 108 is recessed within an exterior surface of the bolt body 107. While each slot of the plurality of slots 108 comprises a recessed planar surface with 90 degree corners, the corners may be rounded, or each slot may comprise a recessed half-cylinder. With the plurality of slots 108 and the plurality of sets of threads 109 only extending up to some distance from the second end 111 of the bolt body 107, a section 112 of the bolt body 102 adjacent to the second end 111 is continuously threaded around the circumference of the bolt body 107. The threads within section 112 have a consistent thread profile around the circumference of the bolt body 107.

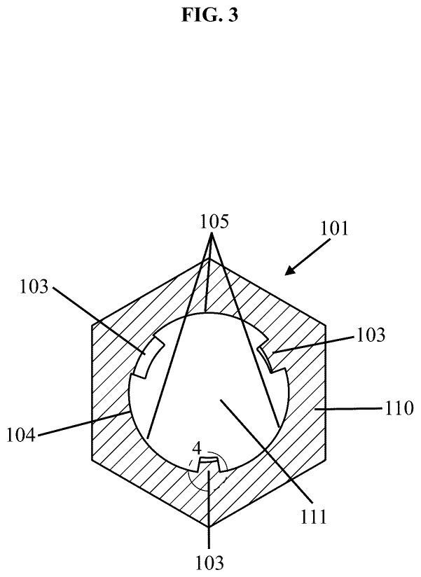

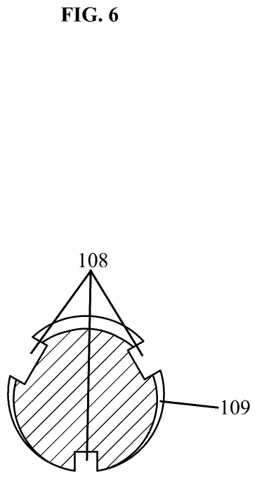

Further shown in FIG. 3, the threaded protrusions of each set of the plurality of sets of threaded protrusions 103 and each longitudinal gap of the plurality of longitudinal gaps 105 vary in dimensions, such as an arc length of the threaded protrusions of each set of the plurality of sets of threaded protrusions 103 and an arc length of each longitudinal gap of the plurality of longitudinal gaps 105, respectively. Further shown in FIG. 6, the threads of each set of the plurality of sets of threads 109 and each slot of the plurality of slots 108 vary in dimensions, such as an arc length of the threads of each set of the plurality of sets of threads 109 and a width of each slot of the plurality of slots 108, respectively. In such a case, each set of the plurality of sets of threaded protrusions 103 corresponds with a slot of the plurality of slots 108 sized to receive the respective set of the plurality of sets of threaded protrusions 103. Similarly, each set of the plurality of sets of threads 109 corresponds with a longitudinal gap of the plurality of longitudinal gaps 105 sized to receive the respective set of the plurality of sets of threads 109. The nut 101 may be rotated 360 degrees relative to the bolt body 107 before each set of the plurality of sets of threaded protrusions 103 realigns with the corresponding particular slot of the plurality of slots 108 sized to receive the respective set of the plurality of sets of threaded protrusions 103. The differing arc length of the threaded protrusions of each set of the plurality of sets of threaded protrusions 103 and differing arc length or width of each slot of the plurality of slots 108 allows the nut 101 to rotate nearly 360 degrees without sliding longitudinally along the bolt body 107.

To couple objects together, the bolt body 107 passes through an opening in each of the objects. Each set of the plurality of sets of threaded protrusions 103 is aligned with a slot of the plurality of slots 108 and each set of the plurality of sets of threads 109 is aligned with a longitudinal gap of the plurality of longitudinal gaps 105. The nut 101 is then translated longitudinally in a first direction along the bolt body 107 until reaching a desired position along the bolt body 107, such as a position wherein the nut 101 is proximal to a clamping surface. The plurality of slots 108 and the plurality of longitudinal gaps 105 facilitate the longitudinal translation of the nut 101 along the bolt body 107 without any obstruction. As long as each set of the plurality of sets of threaded protrusions 103 is aligned with a slot of the plurality of slots 108 and each set of the plurality of sets of threads 109 is aligned with a longitudinal gap of the plurality of longitudinal gaps 105, the nut 101 translates longitudinally along the bolt body 107 from the first end 110 towards the second end 111 without any obstruction, saving time and effort. The nut 101 is tightened to the desired strength to couple the objects together by rotating the nut 101 until at least a portion of the threaded protrusions of the plurality of sets of threaded protrusions 103 engages with at least a portion of the threads of the plurality of sets of threads 109 and/or the threads spanning around the entire circumference of the bolt body 107 in section 112 and the desired clamped force is attained. The threaded protrusions of the plurality of sets of threaded protrusions 103 create a clamping force as the nut 101 is rotated in relation to the bolt body 107 and the threaded protrusions of the plurality of sets of threaded protrusions 103 engage with the threads of the plurality of sets of threads 109 and/or the threads spanning around the entire circumference of the bolt body 107 in section 112 to create a clamped or bolted joint at any point along the length of the bolt body 107 and prevent axial movement. The plurality of sets of threaded protrusions 103 are equally spaced around the circumference of the cylindrical interior surface 104 of the nut 101 to distribute a uniform clamping force on the clamping surface with the rotation and tightening of the nut 101.

FIGS. 1-3 illustrate the nut 101 comprising a nut body 113. The cylindrical interior surface 104 defines a through hole 114 concentric with the nut body 113, through which the bolt body 107 passes. A magnitude of a radius of the through hole 114 is chosen such that the bolt body 107 may fit within the through hole 114, the nut 101 may create a bolted joint with the bolt 102, and the nut 101 may easily translate longitudinally along the bolt body 107 when each set of the plurality of sets of threaded protrusions 103 is aligned with a slot of the plurality of slots 108 and each set of the plurality of sets of threads 109 is aligned with a longitudinal gap of the plurality of longitudinal gaps 105. An exterior surface of the nut body 113 of the nut 101 is preferably hexagonal in shape such that it may be easily gripped by a tool and/or user. In various embodiments, the nut body 110 may comprise different shapes, sizes, orientations, etc., so long as the objectives of the present invention are fulfilled.

FIGS. 1, 5, and 6 illustrate the bolt 102. The bolt head 106 may act as a blocking border or an end surface for a bolted joint. The bolt head 106 is preferably solid and of a shape that can be ergonomically gripped by a tool and/or user, such as a solid hexagonal shape. The bolt head 106 preferably has a smaller height and a larger cross-sectional area than a height and a cross-sectional area of the bolt body 107, respectively. However, in some cases, the bolt head 106 may have a larger height and/or a smaller cross-sectional area than the height and the cross-sectional area of the bolt body 107, respectively. In various embodiments, the bolt body 107 and/or the bolt head 106 may comprise different shapes, sizes, orientations, etc., so long as the intents of the present invention are unaltered. A magnitude of a radius of the bolt body 107 is chosen such that the bolt body 107 may fit within the through hole 114 of the nut 101, the nut 101 may create a bolted joint with the bolt 102, and the nut 101 may easily translate longitudinally along the bolt body 107 when each set of the plurality of sets of threaded protrusions 103 is aligned with a slot of the plurality of slots 108 and each set of the plurality of sets of threads 109 is aligned with a longitudinal gap of the plurality of longitudinal gaps 105.

In various embodiments, the coupling device 100, the nut 101, and the bolt 102 may comprise any size, material, components, arrangement of components, etc., that are known to one of ordinary skill in the art, so long as the intents of the present invention are unaltered. Further, in various embodiments, a size of each slot, a number of slots, a shape of each slot, a size of the threaded protrusions of each set of threaded protrusions, a number of sets of threaded protrusions, a number of threaded protrusions in each set of threaded protrusions, a size of each longitudinal gap, a number of longitudinal gaps, a size of the threads of each set of threads, a number of sets of threads, a number of threads in each set of threads, and a thread size, pitch, and angle of any portion of threads of the coupling device, may vary.

Embodiments include a method of operation of the coupling device 100. The method includes aligning each set of the plurality of sets of threaded protrusions 103 with a slot of the plurality of slots 108 sized to receive the respective set of the plurality of sets of threaded protrusions 103 and aligning each set of the plurality of sets of threads 109 with a longitudinal gaps of the plurality of longitudinal gaps 105 sized to receive the respective the set of the plurality of sets of threads 109; slidingly coupling the nut 101 longitudinally with the bolt body 107 by translating the nut 101 longitudinally along the bolt body 107 from the first end 110 towards the second end 111 of the bolt body 107 until proximal to a clamping surface or the threads surrounding the entire circumference of the bolt body 107 in section 112; and rotating the nut 101 until at least a portion of the threaded protrusions of the plurality of sets of threaded protrusions 103 engages with at least a portion of the threads of the plurality of sets of threads 109 and/or or the threads surrounding the entire circumference of the bolt body 107 in section 112 and the desired clamped force is attained.

It should be understood that the various embodiments described herein are presented by way of example, and that numerous variations, modifications, or combinations of the described embodiments may be made without departing from the scope of the invention. In some instances, certain features of one embodiment may be used in combination with features of another embodiment, or multiple embodiments may be integrated together to achieve a desired result. Additionally, certain elements or steps of the described embodiments may be omitted, substituted, or altered depending on the specific implementation or application.

In various embodiments, certain components, methods, or functionalities described herein may be modified or adapted to fit specific use cases or design constraints. These modifications may be made in view of particular user requirements, environmental conditions, or regulatory considerations.

Alternative configurations of the embodiments described herein are also possible. In some cases, a particular feature described with reference to one embodiment may be utilized in other embodiments, even if not explicitly mentioned. Similarly, the order of steps in a process/method or the arrangement of components in a system or apparatus may be altered, provided that the underlying principles of the invention are maintained.

While particular embodiments have been described, it is to be understood that alternative embodiments may be employed in place of the specifically described forms. In some cases, specific components may be replaced with functionally equivalent alternatives, and in others, operational steps may be rearranged or omitted, all without departing from the spirit and scope of the invention.

1. A coupling device, comprising:
a female component comprising a plurality of sets of threaded protrusions; and
a male component, comprising:
a plurality of longitudinal slots; and
a plurality of sets of threads;
wherein:
the plurality of sets of threaded protrusions protrude from an interior surface of the female component;
threaded protrusions of each set of the threaded protrusions are oriented longitudinally on the interior surface of the female component;
the plurality of sets of the threaded protrusions delineate at least one longitudinal gap on the interior surface of the female component;
the plurality of longitudinal slots are recessed into an exterior surface of the male component;
each slot of the plurality of slots and threads of each set of the plurality of sets of threads are oriented longitudinally on the exterior surface of the male component and are arranged around a circumference of the male component in alternation;
a number of longitudinal slots match a number of sets of threaded protrusions;
each longitudinal slot of the plurality of longitudinal slots is sized to receive a respective set of threaded protrusions;
a number of the at least one longitudinal gap match a number of sets of threads;
each longitudinal gap of the at least one longitudinal gap is sized to receive a respective set of threads;
a dimension of the threaded protrusions of each set of the plurality of sets of threaded protrusions differ;
a dimension of each longitudinal gap of the at least one longitudinal gap differ; and
a dimension of each longitudinal slot of the plurality of longitudinal slots differ.

2. The coupling device of claim 1, wherein:
the female component comprises a nut;
the male component comprises a bolt, comprising:
a bolt head; and
a bolt body;
the interior surface of the female component comprises an interior cylindrical surface of the nut;
the plurality of sets of threaded protrusions protrude from the interior cylindrical surface of the nut;
the threaded protrusions of each set of threaded protrusions are oriented longitudinally on the interior cylindrical surface of the nut;
the plurality of sets of the threaded protrusions delineate at least one longitudinal gap on the interior cylindrical surface of the nut;
the plurality of longitudinal slots are recessed into an exterior surface of the bolt body;
each slot of the plurality of slots and threads of each set of the plurality of sets of threads are oriented longitudinally on the exterior surface of the bolt body and are arranged around a circumference of the bolt body in alternation; and
the nut is fastened onto the bolt to clamp two or more objects together, forming a bolted joint.

3. The coupling device of claim 1, wherein the coupling device provides a threaded fitting between the female component and the male component.

4. The coupling device of claim 1, wherein:
the plurality of longitudinal slots and the at least one longitudinal gap extend longitudinally from a first end of the male component to a distance from a second end of the male component; and
other threads are disposed continuously around the circumference of the male component adjacent to the second end of the male component, the other threads comprising a consistent thread profile around the circumference of the male component.

5. The coupling device of claim 1, wherein:
each set of the plurality of sets of threaded protrusions are spaced evenly apart around a circumference of the interior surface of the female component;
each longitudinal gap of the at least one longitudinal gap are spaced evenly apart around the circumference of the female component;
each longitudinal slot of the plurality of longitudinal slots are spaced evenly apart around the circumference of the male component; and
each set of the plurality of sets of threads are spaced evenly apart around the circumference of the male component.

6. The coupling device of claim 1, wherein:
each set of the plurality of sets of threaded protrusions are spaced unevenly apart around a circumference of the interior surface of the female component;
each longitudinal gap of the at least one longitudinal gap are spaced unevenly apart around the circumference of the female component;
each longitudinal slot of the plurality of longitudinal slots are spaced unevenly apart around the circumference of the male component; and
each set of the plurality of sets of threads are spaced unevenly apart around the circumference of the male component.

7. The coupling device of claim 1, wherein:
the dimension of the threaded protrusions of each set of the plurality of sets of threaded protrusions that differs comprises an arc length;
the dimension of each longitudinal gap of the at least one longitudinal gap that differs comprises an arc length or width; and
the dimension of each longitudinal slot of the plurality of longitudinal slots that differs comprises an arc length or width.

8. The coupling device of claim 1, wherein:
the interior surface of the female component is cylindrical;
the interior surface defines a hole concentric with the female component; and
the male component is cylindrical.

9. The coupling device of claim 1, wherein the desired position is adjacent to one of: a clamping surface, a blocking border, or an end surface.

10. The coupling device of claim 1, wherein:
the plurality of sets of threaded protrusions comprises three sets of threaded protrusions; and
the plurality of longitudinal slots comprises three longitudinal slots.

11. The device of claim 1, wherein each of the plurality of longitudinal slots comprises at least one of: a planar surface recessed within the exterior surface of the male component, a planar surface with rounded edges recessed within the exterior surface of the male component, and a half-cylinder recessed within the exterior surface of the male component.

12. A method for operating a coupling device, comprising:
aligning each set of threaded protrusions protruding from an interior surface of a female component of the coupling device with a longitudinal slot recessed in an exterior surface of a male component of the coupling device, the longitudinal slot being sized to receive the respective set of threaded protrusions;
aligning each set of threads disposed on the exterior surface of the male component with a longitudinal gap disposed on the interior surface of the female component, the longitudinal gap being sized to receive the respective set of threads;
translating the female component in a first longitudinal direction along the male component, from a first end of the male component to a second end of the male component, until reaching a desired position along the male component; and
rotating the female component relative to the male component to fasten the female component onto the male component;
wherein:
the female component comprises a plurality of sets of threaded protrusions;
the male component, comprises:
a plurality of longitudinal slots recessed into the exterior surface of the male component; and
a plurality of sets of threads;
the plurality of sets of threaded protrusions protrude from the interior surface of the female component;
threaded protrusions of each set of the threaded protrusions are oriented longitudinally on the interior surface of the female component;
the plurality of sets of the threaded protrusions delineate at least one longitudinal gap on the interior surface of the female component;
the plurality of longitudinal slots are recessed into the exterior surface of the male component;
each slot of the plurality of longitudinal slots and threads of each set of the plurality of sets of threads are oriented longitudinally on the exterior surface of the male component and are arranged around a circumference of the male component in alternation;
a number of longitudinal slots match a number of sets of threaded protrusions;
each longitudinal slot of the plurality of longitudinal slots is sized to receive a respective set of threaded protrusions;
a number of the at least one longitudinal gap match a number of sets of threads;
each longitudinal gap of the at least one longitudinal gap is sized to receive a respective set of threads;
the female component is rotated until:
at least a portion of threaded protrusions of the plurality of sets of threaded protrusions engages with one or more of: at least a portion of threads of the plurality of sets of threads or at least a portion of other threads disposed continuously around a circumference of the male component; and
a desired clamped force is attained;
a dimension of the threaded protrusions of each set of the plurality of sets of threaded protrusions differ;
a dimension of each longitudinal gap of the at least one longitudinal gap differ; and
a dimension of each longitudinal slot of the plurality of longitudinal slots differ.

13. The method of claim 12, wherein:
the female component comprises a nut;
the male component comprises a bolt, comprising:
a bolt head; and
a bolt body;
the interior surface of the female component comprises an interior cylindrical surface of the nut;
the plurality of sets of threaded protrusions protrude from the interior cylindrical surface of the nut;
the threaded protrusions of each set of the threaded protrusions are oriented longitudinally on the interior cylindrical surface of the nut;
the plurality of sets of the threaded protrusions delineate at least one longitudinal gap on the interior cylindrical surface of the nut;
the plurality of longitudinal slots are recessed into an exterior surface of the bolt body;
each slot of the plurality of slots and threads of each set of the plurality of sets of threads are oriented longitudinally on the exterior surface of the bolt body and are arranged around a circumference of the bolt body in alternation; and
the nut is fastened onto the bolt to clamp two or more objects together, forming a bolted joint.

14. The method of claim 12, wherein the coupling device provides a threaded fitting between the female component and the male component.

15. The method of claim 12, wherein:
the plurality of longitudinal slots and the at least one longitudinal gap extend longitudinally from the first end of the male component to a distance from the second end of the male component; and
the other threads disposed continuously around the circumference of the male component are adjacent to the second end of the male component and comprise a consistent thread profile around the circumference of the male component.

16. The method of claim 12, wherein:
each set of the plurality of sets of threaded protrusions are spaced evenly apart around a circumference of the interior surface of the female component;
each longitudinal gap of the at least one longitudinal gap are spaced evenly apart around the circumference of the female component;
each longitudinal slot of the plurality of longitudinal slots are spaced evenly apart around the circumference of the male component; and
each set of the plurality of sets of threads are spaced evenly apart around the circumference of the male component.

17. The method of claim 12, wherein:
each set of the plurality of sets of threaded protrusions are spaced unevenly apart around a circumference of the interior surface of the female component;
each longitudinal gap of the at least one longitudinal gap are spaced unevenly apart around the circumference of the female component;
each longitudinal slot of the plurality of longitudinal slots are spaced unevenly apart around the circumference of the male component; and
each set of the plurality of sets of threads are spaced unevenly apart around the circumference of the male component.

18. The method of claim 12, wherein:
the dimension of the threaded protrusions of each set of the plurality of sets of threaded protrusions that differs comprises an arc length;
the dimension of each longitudinal gap of the at least one longitudinal gap that differs comprises an arc length or width; and
the dimension of each longitudinal slot of the plurality of longitudinal slots that differs comprises an arc length or width.

19. The method of claim 12, wherein:
the interior surface of the female component is cylindrical;
the interior surface defines a hole concentric with the female component; and
the male component is cylindrical.

20. The method of claim 12, wherein the desired position is adjacent to one of: a clamping surface, a blocking border, or an end surface.
